(19) United States
(12) Patent Application Publication
(10) Pub. No.: US 2008/0311901 A1
(43) Pub. Date: Dec. 18, 2008

(54) Method and Apparatus for Evaluating the Performance of a Radiomobile Transmission System

(76) Inventors: Simone Bizzarri, Torino (IT); Giuseppe Costanzo, Torino (IT); Luciano Gabrielli, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/659,327

(22) PCT Filed: Aug. 5, 2004
(86) PCT No.: PCT/IT2004/000441

§ 371 Date: Feb. 5, 2007

(51) Int. Cl. H04Q 7/34

(52) U.S. Cl. 455/424

(57) ABSTRACT

A method for evaluating the performance of a radiomobile system including a core network, includes the steps of generating a signal through a first device and transmitting the signal to a second device through the core network, wherein the transmission step includes emulating a radio access network interposed between the first device and the core network.

The present invention relates to the field of radiomobile transmission systems and to a method and apparatus for evaluating the performance of such a system.

A radiomobile network is known to comprise two major sections: the core network CN and the radio access network RAN. Generally, the switching and routing apparatuses are included in the core network, whereas the access network comprises, inter alia, the base stations of the radiomobile network dealing with the radiofrequency processing.

In the radiomobile communications the need of evaluating the characteristics and the quality of the service even before it is inserted in the operational radiomobile network is particularly felt. This is partially due to the fact that many services available on the radiomobile networks are subject to a fast evolution. For example, one may mention e-mail packet services, web browsing and video-streaming.

This need has led to the use of apparatuses intended to emulate particular sections of the radiomobile network. The international patent application WO-03/028394 describes a communication system comprising a user terminal (consisting of a personal computer) connected to an emulating apparatus, which is connected in turn to an operating terminal. The operating terminal can respond to web browsing functions activated by the user terminal, by means of the emulator. According to this patent application, the emulator is capable of emulating radiomobile network effects on the data exchanged between the operating terminal and the user terminal.

The Applicant observes that the emulator described in the above international patent application is capable of emulating only the effects of the radio channel associated to a user, but not of an entire radiomobile network comprising a radio access network and a core network.

Furthermore, an apparatus for traffic simulation and network performance evaluation is commercially available from Tekelec, model MGTS-i300. This conventional apparatus can be connected to several points of a radiomobile network to carry out a test on specific apparatuses. For example, in a UMTS system said apparatus enables to test (by being connected to these apparatuses through suitable interfaces):

a Node-B, simulating a RNC (Radio Network Control) connected to this Node-B;

a RNC, simulating a node-B connected either to the RNC or the core network;

the core network, simulating one or more UTRANs (UMTS Terrestrial Radio Access Network);

a GGSN (Gateway GPRS Support Node) simulating one or more SGSN (Service GPRS Support Node).

Both the network performance evaluation modes described above (the one described in WO-03/028394 and the other to be implemented by the MGTS-i300 apparatus) have drawbacks and do not provide sufficiently exhaustive emulations for current requirements. Particularly, in both cases the network emulation is partial, since networks parts or connection functionalities are omitted (for example, some typical protocols of a real network operation are not generated) the effects of which are often not negligible. For example, the system described in WO-03/028394 does not emulate the behaviour of the core network and the effect of the interconnections existing in a real network (particularly, the RAN-terminal, RAN-CN, CN-server interconnections), whereas the system employing the MGTS-i300 apparatus does not emulate the behaviour both of the radio channel and the radio access, and does not introduce the contribution deriving from the unsolicited parts (such as the real user) and their interaction with the remainder of the network. Furthermore, the system employing the MGTS-i300 apparatus does not generate a real traffic, but it generates signals based on mathematical models.

The Applicant has addressed the problem of proposing a method for evaluating the performance of a radiomobile system that overcomes some of the drawbacks of the conventional emulation methods, thus being more complete and effective than the known techniques.

The Applicant has found that the evaluation of the performance of a radiomobile network can be made in a particularly effective and complete manner, particularly taking into account all the contributions from the various parts of a real network, using a real network, a first and a second real terminal devices capable of mutually exchanging information through the real network, and an access network emulation apparatus interposed between at least one of the terminal devices and the core network. The emulation apparatus of the present invention is capable of emulating both the behaviour of a mobile terminal associated to the terminal device to which it is connected and the behaviour of a radio access network connected to the core network.

Therefore, according to a first aspect, the present invention relates to a method for evaluating the performance of a radiomobile system including a core network, comprising the steps of generating a signal through a first device and transmit said signal to a second device through the core network, wherein the transmission step comprises emulating a radio access network interposed between the first device and the core network.

By the term “interposed” it is meant arranged along the signal transmission route.

The first and second devices are real devices, such as computers, generating real signals.

The step of emulating a radio access network preferably comprises emulating a radio channel, particularly a radio channel associated to the first device.

Preferably, the method also comprises the further step of emulating the behaviour of a first user mobile terminal associated to the first device.

Moreover, the step of emulating a radio access network can comprise the step of exchanging with the core network information associated to a radiomobile connection of the first device to the second device and such as to allow the core network to recognize the radio access network being emulated.

The method can also comprise the step of evaluating the quality of transmission between the first and second devices based on the transmitted signal.

Advantageously, the first and second devices comprise a respective computer and the step of transmitting a signal comprises carrying out a connection of the client-server type to exchange data between the first and second devices.

The method can comprise the further step of emulating the behaviour of a second user mobile terminal associated to the second device.

Furthermore, the emulated radio access network can be also interposed between said second device and said core network.

The step of emulating a radio access network preferably comprises the step of generating first signals indicative of a first plurality of parameters (PAR_{TP}) such as to define a topology of the emulated access network.

The step of emulating the behaviour of a first user mobile terminal preferably comprises the step of generating second signals indicative of a second plurality of parameters such as to define the behaviour over time of the first user mobile terminal.

Preferably, the step of emulating the behaviour of a radio channel associated to the first terminal comprises the step of generating third signals indicative of a third plurality of parameters (PAR_{TP}) such as to define the behaviour over time of the radio channel emulated.

The step of emulating a radio access network can further include a first step of initialization of the access network comprising the steps of:

sending signals descriptive of the typology of the emulated access network and correlated to the first plurality of parameters (PAR_{TP}) to the core network, and

receiving (5) a first signal of success of the first initialization step from the core network.

The first initialization step can also comprise, before the step of sending the signals descriptive of the topology of the emulated access network to the core network, the step of carrying out a conversion of the descriptive signals from a first protocol to a second user-plane protocol associated to the core network.

The step of emulating the behaviour of a first user mobile terminal can also comprise a second user initialization step comprising the steps of:

sending signals related to a first terminal signalling procedure and correlated to the second plurality of parameters (PAR_{CH}) to the core network, and

receiving a second signal of success of the second initialization step from the core network.

The second initialization step can further comprise, before the step of sending signals related to a first terminal signalling procedure to the core network, the step of carrying out a conversion of the signals related to the signalling procedure from a first protocol to a second protocol, the second protocol being a user-plane protocol associated to the core network.

Preferably, the step of transmitting a signal from the first to the second device comprises a first data-sending step and the step of emulating the behaviour of a radio channel comprises the steps of:

processing these data by emulating the effect of the radio channel on the data,

associating to the processed data an address information consistent with the address associated by the core network to the first terminal, and

processing the data having the address information associated thereto in order to organize them according to a core network-specific control-plane protocol.

Furthermore, the step of transmitting a signal from the first to the second device preferably comprises a second step of sending further data from the second device to the first device comprising the steps of:

receiving the further data supplied by the second device from the core network,

changing the protocol associated to these further data,

processing the further data to emulate the effect of the radio channel, and

receiving the further data at the first device.

Preferably, at least one of said first (PARTP), second (PARUS) and third (PARCH) plurality of parameters includes at least a parameter varying over time such as to take on a first value corresponding to a first configuration to be emulated and a second value corresponding to a second configuration to be emulated.

Preferably, the radiomobile system is a UMTS system (Universal Mobile Telecommunications System) or a GPRS system (General Packet Radio Service).

Advantageously, the transmitted signal can comprise video data.

In a second aspect, the present invention relates to a system for evaluating the performance of a radiomobile system including a core network, comprising: a first device operatively connected to the core network and suitable to generate a transmission signal, a second device operatively connected to the core network and suitable to receive said signal through the core network, and an apparatus emulating a radio access network operatively interposed between the core network and at least one of said first and second devices.

Preferably, the emulating apparatus comprises a radiomobile channel emulator.

Preferably, the channel emulator is operatively connected to at least one of said first and second devices.

The emulating apparatus can further comprise a signalling and protocol adaptation emulator operatively interposed between the channel emulator and the core network.

Preferably, the emulating apparatus also comprises a control unit suitable to control the channel emulator and the signalling and protocol adaptation emulator.

The emulating apparatus can further comprise a user terminal emulator suitable to emulate the behaviour of a mobile terminal associated to one of said first and second devices.

Advantageously, the signalling and protocol adaptation emulator comprises an emulator of radio access network elements.

The signalling and protocol adaptation emulator preferably also comprises a unit for the Control-Plane protocol transformation.

Moreover, the signalling and protocol adaptation emulator preferably also comprises a unit for the User-Plane protocol transformation.

The signalling and protocol adaptation emulator can further comprise a interface module network adapter suitable to adapt the interface to the core network.

In a first embodiment, the emulating apparatus is interposed between the first device and the core network and the second device is a server, to provide a client-server connection.

In a second embodiment, the emulating apparatus is interposed between said devices and the core network, to provide a peer-to-peer connection.

In this latter case, the emulating apparatus preferably comprises a user terminal emulator suitable to emulate the behaviour of a first mobile terminal associated to the first device and a second mobile terminal associated to the second device.

In a further aspect thereof, the present invention relates to an apparatus for emulating a portion of a radiomobile communication system, the apparatus comprising:

a processing block suitable to receive and process the signal generated by a communication device and transmitted on a radio channel, and

an interface/adaptation block to be connected to a core network of the radiomobile communication system and suitable to allow the exchange of signals between the processing block and the core network.

Preferably, the processing block comprises an emulator of radio access network elements suitable to emulate the behaviour of at least one part of a radio access network.

Still more preferably, the emulator of radio access network elements is suitable to emulate the whole radio access network.

Preferably, said apparatus also comprises a radio channel emulator suitable to be interconnected between the communication device and the processing block and to emulate the behaviour of the radio channel.

The interface/adaptation block preferably comprises a Control-Plane protocol transformer and a User-Plane protocol transformer.

The processing block can comprise a user terminal emulator suitable to emulate the behaviour of a mobile terminal associated to the communication device.

The characteristics and the advantages of the present invention will be made apparent from the description below of a preferred embodiment thereof, given by way of a non-limiting example, with reference to the annexed figures wherein:

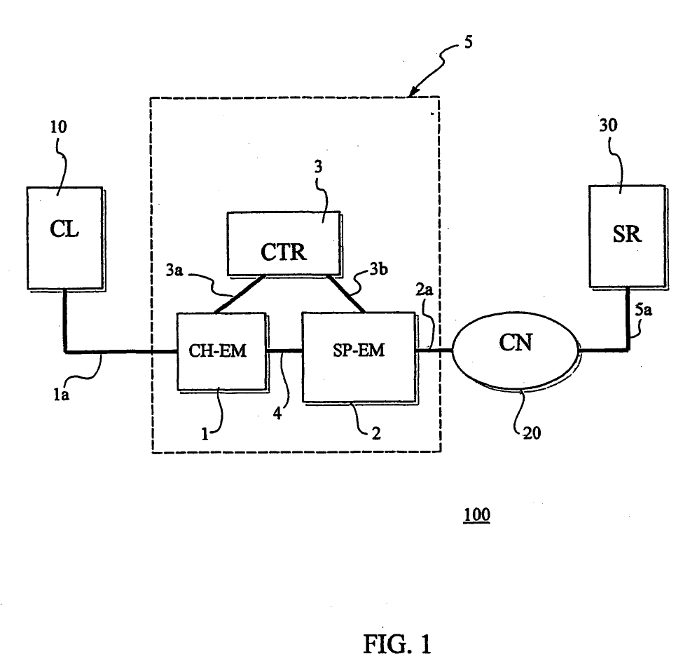

FIG. 1 schematically shows the architecture of an emulated radiomobile communication system, in accordance with an embodiment of the present invention;

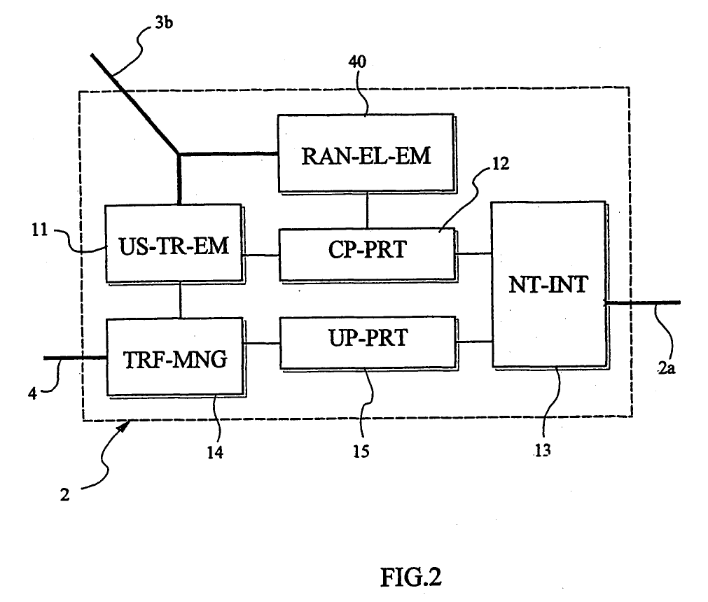

FIG. 2 schematically shows by functional blocks the exemplary architecture of an emulator/adapter to be used in the system from FIG. 1;

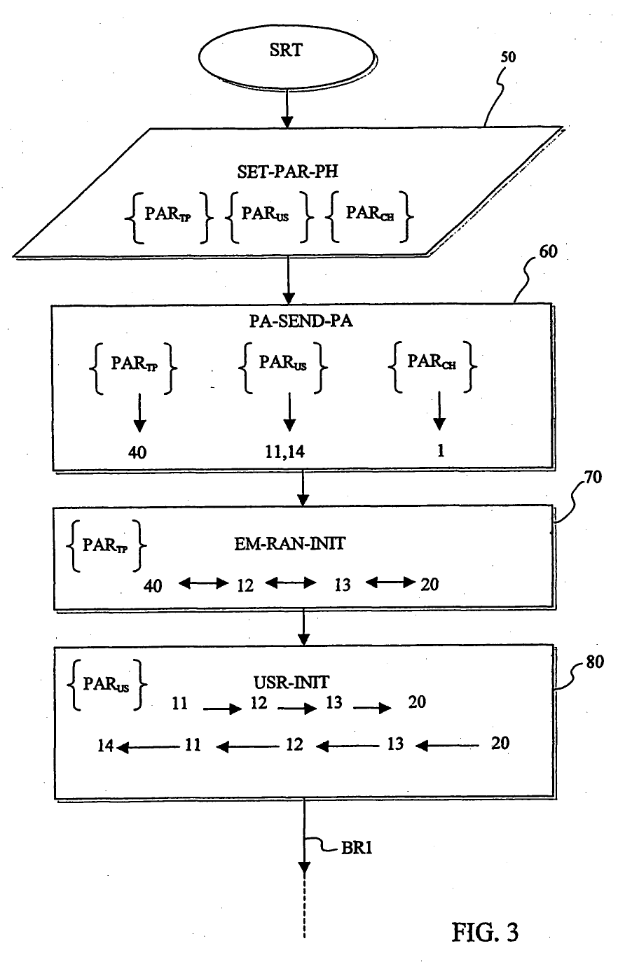

FIGS. 3-5 are overall views of a flow diagram relative to an example of an operating method of the system from FIG. 1.

FIG. 1 schematically shows a emulated radiomobile communication system 100 including a first device 10 (CL), an radio access network emulating apparatus 5, a core network 20 (CN), and a second device 30 (SR).

The first device 10 can be, for example, a conventional computer (such as a personal computer PC) intended to act, for example, as the client. Particularly, the first device 10, by operating based on conventional software applications, is preferably capable of activating either in the uplink mode (transmission) or in the downlink mode (receipt), at least one of the following functions: web-browsing, e-mail, video-streaming. In the following, reference will be made to the case where the first device 10 is a user terminal, particularly a client computer.

It should be noted that, advantageously, the client computer 10 is a real device, i.e. not emulated by a software, but including for example, memories, a processing unit, user interfaces (for example, a keyboard, a display) and is such as to operate with other computers belonging to a real, i.e. not emulated, radiomobile telecommunication system. The client computer 10 is connected to the emulating apparatus 5 by means of a first connection 1a comprising, for example, transmission lines providing an Ethernet-type connection, known per se, which allows the exchange of data and commands with this apparatus 5.

Advantageously, the second device 30 is also a real device and, for example, it is such to activate typical functions of a network server such as the management and provision of resources. Particularly, the second device 30 (in the following denominated as the computer server, in accordance with the subject example) allows to respond to the client computer 10 and can comprise a suitable conventional computer. Particularly, the computer server 30 is able to respond, for example, to the web-browsing functions activated by the client computer 10 and send corresponding information to the latter (for example, in the form of data packets). The client computer 10 can be associated either to a real or dummy user. The computer server 30 is connected to the core network 20 by means of a connection 5a made, for example, with a link of the core network 20.

As an alternative to the system configuration represented in FIG. 1, which connects a client computer to a server computer, a configuration can be used (not shown) in which two computers are both connected to the emulating apparatus 5 and can communicate through the emulating apparatus 5 and the core network 20. The evaluation of the network performance can then be carried out also in the absence of a server computer.

The core network 20 is a real network (i.e. not emulated) and comprises apparatuses (such as, for example, switching and routing apparatuses) which are known to those skilled in the art, and being such as to be able to perform functions like user authentication, storage of localization information, negotiation of the modes and quality of the access to services, generation of taxation information, connection to a user and various server services. As is known to those skilled in the art, in the case of a GPRS communication system, the core network 20 includes two types of main elements or nodes: the Serving GPRS Support Node (SGSM) and the Gateway GPRS Support Node (GGSM). The nodes of the SGSN type perform a number of functions, such as routing functions, handover and IP address assignment (Internet Protocol). A node of the GGSM type performs the functions of gateway, routing and firewall. In the case of UMTS system, the definitions of these main nodes are similar to those of the GPRS system.

Particularly, the connection 5a is interfaced to a GGSM node, whereas a SGSM node of the core network 20 is connected (by means of a second connection 2a) to the emulating apparatus 5. The emulating apparatus 5 is able to emulate the behaviour of a Radio Access Network RAN.

By “emulator” or “emulating apparatus” of a network element or a real device is meant herein an apparatus capable of carrying out (while running a real-time software) all or some of the functions of the network element or real device, and is also capable of generating events changing an emulated situation both in response to a command originated via software and in response to information supplied by other components to which it is connected.

According to a particular embodiment of the invention, the emulating apparatus 5 comprises a control terminal 3 (CTR), a radiomobile channel emulator 1 (CH-EM) and a signalling and protocol adaptation emulator 2 (SP-EM), in the following indicated as the emulator/adapter.

The control terminal 3 is connected to the radiomobile channel emulator 1 and to the emulator/adapter 2 by means of third 3a and fourth 3b connections, respectively, such as to be able to transmit information such as data and/or control signals to both emulators 1 and 2.

The communication between the third and fourth connections 3a and 3b can be made, for example, either according to a protocol of the Ethernet type or by means of another local network protocol. The control terminal 3 can be implemented, by way of example, by a personal computer (Personal Computer, PC).

The radiomobile channel emulator 1 (for brevity reasons, it will be indicated as the channel emulator 1 in the following) is a device suitable to control the data exchange between the client computer 10 and the simulator/adapter 2, by emulating, based on command signals received from the control terminal 3, the behaviour of a radio channel of an access network. The channel emulator 1 is connected to the emulator/adapter 2 by means of a fifth connection 4, preferably of the Ethernet type. This channel emulator can be, advantageously, implemented similar to the emulator described in the international patent application WO03/028394 with reference to FIG. 2 and indicated therein with the numeral 12. The description provided in the international patent application WO03/028394 concerning this emulator is to be considered as being included by reference in the present patent application. The channel emulator 1 can be a separate device from the control terminal 3 and comprises a respective computer (not shown) provided of a processing unit, mass and working storages connected from a bus to the processing unit, and interfaces with the first connection 1a and fifth connection 4. The channel emulator 1 can perform a processing of signals (for example, packed digital data) either transmitted to or received from the client computer 10 by simulating the effect of a radio channel, while running a corresponding software.

The emulator/adapter 2 performs a number of functions. This emulator/adapter 2 is suitable to emulate elements of a RAN network (such as the stations provided therein) by carrying out, particularly, the signalling procedures normally performed by a radio access network and addressed to the core network 20. For example, it is able to emulate the base stations BSS (Base Station System) of a GPRS communication system (General Packet Radio Service) or the UTRAN stations (Universal Terrestrial Radio Network) of a UMTS system (Universal Mobile Telecommunications System).

Furthermore, the emulator/adapter 2 is able to emulate in real-time the behaviour over time of a first dummy (not real) user terminal and associated to the client computer 10, for example a mobile phone that the user would connect to his own client computer 10 to make use of the desired service. To the purpose, it should be observed that the emulated system 100 can be employed to emulate the connection between several server computers and several client computers and not only for one single client 10 and server 30 computer. In the case where several client computers are emulated, the emulator/adapter 2 emulates a plurality of dummy user terminals, each being associated to a respective client computer.

The emulator/adapter 2 also carries out conversions to adapt the protocols employed by the core network 20 to those employed by the emulated RAN elements and first user terminal, and vice versa.

FIG. 2 shows (corresponding to software and/or hardware modules) an example of architecture of the emulator/adapter 2 by means of functional modules. This emulator/adapter 2 comprises a first module 40 (RAN-EL-EM) emulator (advantageously, in real-time) of RAN elements, being connected to the control terminal 3 by means of the fourth connection 3b. Furthermore, the emulator/adapter 2 is provided with a second module 11 (US-TR-EM) emulator of user terminal and a third module 14 (TRF-MNG) for managing the user traffic. There are included within the emulator/adapter 2 also a fourth module 12 (CP-PRT) for the Control-Plane protocol transformation and a fifth module for the User-Plane protocol transformation 15 (UP-PRT), having respective outputs connected to a network adapter interface block 13 (NT-INT).

The first emulating module 40 can receive from the control terminal 3 data corresponding to the topological description of the RAN to be emulated and the configuration parameters thereof, and generate control messages to be sent to the core network 20. Furthermore, the first module 40 can receive control messages from the core network 20 and in the case where it detects the beginning of procedures started by the core network 20 (for example, reset, block, unblock of connections or links), it can autonomously manage them, or rather send them to the control terminal 3, when an action is required by an operator.

The second user terminal emulating module 11 is particularly intended to emulate the first user terminal associated to the client computer 10. The second module 11 emulates the behaviour of the first user terminal by sending corresponding control messages to the core network 20. For example, these control messages emulate the management signals of the movements from one cell to another (mobility) of the first terminal and the signal requiring the establishment of a connection to the server computer to access the service.

The third module 14 is able to receive signals relative to the service to be evaluated (for example, packets of a video-streaming connection) from the channel emulator 1 and, based on the configuration which has been set thereto by second module 11, to send these signals to the core network 20. While sending these signals to the core network 20 (through the fifth module 15), the third module 14 adapts the data of the communication protocols used such that the signals appear to the core network 20 as these signals have been originated from a real terminal that had requested the service. Particularly, this adaptation can require an IP address conversion (internet Protocol) between the IP address used on the Ethernet connection 1a and 4 and that used by the core network 20. The first module 40 and second module 11 are, preferably, software modules and are specifically designed.

The fourth module 12 is such to implement the control protocols specific for the core network 20 to which the simulator/adapter 2 is connected, and which are known in the field with the name of control-plane protocols. For example, the BSSGP protocol (Base Station System GPRS Protocol) for the GPRS system or the RANAP protocol (Radio Access Network Application Protocol) for the UMTS system are implemented. This fourth module 12 has the function of transforming the signalling procedure requests (for example, mobility management, session management, call control, etc.) initiated by the first module 40 and second module 11, into specific messages of the protocol operating on the core network 20 being used.

The fifth module 15 implements the user-plane protocols specific of the core network 20 to which it is connected such as, for example, SNDCP protocol (Sub-Network Dependent Convergence Protocol) for the UMTS system or GTP protocol (GPRS Tunnel Protocol) for the GPRS system.

This fifth module 15 is such as to transform the signals (i.e. for example, the data packets containing useful information) from the client terminal 10 into signals organized in frames to be transmitted on the core network 20 by means of the adapter block 13. Furthermore, the fifth module 15 routes the data from the core network 20 to the client terminal 10 by carrying out a mapping of the addresses. It should be observed that the meaning of the user-plane and control-plane protocols is well known to those skilled in the art, and briefly, the first protocol (user-plane) refers to the communication between users whereas the second protocol (control-plane) mainly refers to the signalling procedures between a user and the network. Both the user-plane and the control-plane protocols each comprise seven layers of the OSI model, Open System Interconnection: physical layer, data connection, network, transport, session, presentation, application.

The fourth module 12 and fifth module 15 are, preferably, software modules and can be implemented on a conventional electronic tester available from Tektronix Inc., Wilsonville, Oreg. (USA) model K1297-Protocol Tester provided with programmable hardware and software platforms.

The adapter interface block 13 allows to physically connect the simulator/adapter 2 to the core network 20 and can comprise a hardware electronic board driven by the fourth and fifth modules, 12 and 15. This electronic board is, for example, a E1 electric board for Gb interface or Ethernet board for Gn interface in the case of GPRS system, or a STM1 optical board for Iu interface in the case of UMTS system. The softwares corresponding to the first module 40, second module 11 and third module 14 and the adapter block electronic board 12 can reside in the same tester (for example, said Tectronix K1297) in which the other modules of the emulator/adapter 2 are implemented.

In the following, with reference to FIGS. 3-5, there is described an exemplary emulation method in accordance with the invention, employing the emulated communication system 100 described above. In FIGS. 3-5 the operations of sending signals among the various components of system 100 are depicted with arrows directed from a component to another one, and the whole method starts and ends with conventional start (SRT) and end (ED) steps, respectively.

The emulation method of the invention, which is suitable to the evaluation of the performance of a radiomobile system, includes a preparation step and an execution step.

The preparation step, which is implemented by means of the control terminal 3, provides a setting step 50 (SET-PAR-PH) of the parameters characterizing the emulation to be carried out. These parameters can be divided into a first group (topologic parameters PAR_{TP}), a second group (user parameters PAR_{US}) and a third group (channel parameters PAR_{CH}).

The first group PAR_{TP} comprises those parameters defining the topology of the access network to be emulated, for example: the number of the cellular system cells, their identity, the number of base stations and the parameters thereof, the number and characteristics of the links to the core network 20.

The second group PAR_{US} comprises those parameters defining the user terminals to be emulated (i.e. mobile phones to be emulated) and the user profile, such as the identity of these user terminals and the capacity thereof. In the example described herein, only the first user terminal associated to the client computer 10 is emulated, though as stated above, other user terminals, either associated or not to external real devices, such as other client computers can be emulated. Moreover, this second group comprises parameters describing the behaviour over time of the mobile user terminals when using the service such as, for example, characteristics and duration of the connections and description of their movements from one cell to another across the served territory.

The third group PAR_{CH} comprises parameters defining the behaviour of the radio channel over time, such as, for example, radio resource availability level, slot allocation development, and more particularly, packet lost, overcrowded network and other incidental events that may be found on a real radio access network to which the emulated channel belongs. The third group of parameters PAR_{CH} corresponding- to these events can be experimentally measured or be hypotized by physical-mathematical models.

Advantageously, these three groups of parameters not only define an initial configuration of the connection between the client terminal 10 and the server terminal 30, but also an evolution thereof towards other desired configurations to be emulated. The three parameter groups can form a software document (“script”) containing instructions for the emulating apparatus 5 and be stored in a database with which the control terminal 3 is provided.

Moreover, the preparing step includes a parameter-sending step 60 (PAR-SEND-PH) to the modules intended to operate therewith. The first parameter group PAR_{TP} is sent to the first module 40 which has the functions of emulating the elements of the radio access network RAN in real time. The second parameter group PAR_{US} is made available to second module 11, which has the functions of emulating user terminals in real time, and to third module 14, which will carry out, subsequently, an address translation IP (GPRS case). On the other hand, the third parameter group PAR_{CH} will be sent to the channel emulator 1 (FIG. 1) that will be able to reproduce the behaviour of a radio channel in such conditions as determined by the operator of the communication system 100. Once the preparing step has been completed, an execution step will be started, which can be divided in turn into two major steps: initialization and connection.

The initialization step provides a first initialization step 70 (EM-RAN-INIT) where the first module 40 carries out initialization procedures towards the core network 20, which are suitable to present the typology of the desired radio access network to be emulated to the core network. In this step, the first module 40 either sends or makes available initialization messages depending on the first group of associated parameters as mentioned above to first module 12. These initialization messages are converted by fourth module 12 in corresponding messages in accordance with the control protocol (control-plane protocol) specific for the core network 20. For example, these messages refer to the handshaking procedures, link initialization and transmission layer keep-alive, etc.

The messages produced by fourth module 12 are converted by the interface block 13 into signals suitable to be physically sent to second connection 2a to reach the core network 20.

The core network 20 receives these signals, and by its switching centres, carries out a procedure for the recognition (for example, it distinguishes a RAN network for a GPRS system from one for a UMTS system) and acceptance of the emulated access network. If this procedure is successful, the core network 20 will send corresponding signals to the emulating apparatus 5, which are indicative of the success of the initialization procedure. Once these procedures have been completed, the first module 40 informs the control terminal 3 on the success of the initialization step. Subsequently, the control terminal 3 sends a trigger signal to the second module 11 and the channel emulator 1, which switch to an active state.

Subsequent to the trigger signal, a second initialization step 80 (USR-INIT) will be started in which the second module 11, by following the instructions corresponding to parameters PAR_{US} of second group being supplied by the control terminal 3, carries out signalling procedures relative to those user terminals to be emulated (for example, only the first user terminal associated to the client computer 10) by emitting corresponding messages converted by fourth module 12 according to the specific control-plane protocol. These messages are then sent to the core network 20 through the interface block 13 and the second connection 2a. For example, the procedures required for the registration of the user associated to the first terminal, the authentication thereof, the service request (with a particular desired quality), the establishment of a channel, and the identification of a first cell CELL1 where there is the first user terminal are carried out in this step. In the particular case of GPRS/UMTS systems, these signalling messages of the simulated user terminals refer, for example, to the “Attach” procedures, activation of PDP (“Packet Data Protocol”) context with determined service quality and access point, and “routing area update”, well known to those skilled in the art.

If the second initialization step 80 is successfully accomplished, a communication channel is established between the client computer 10 and the server device computer 30. A success signal can also be sent by the core network core network 20. Following the establishment of the communication channel, the second module 11 initializes the third module 14 based on the second parameter group PAR_{US} and, particularly, based on the information required for the protocol adaptation transmitted by the core network 20 and received by means of the interface block 13 and the fourth module 12. After the initialization of third module 14, the second module 11 sends a signal indicative of the end of this initialization to the control terminal 3.

After the initialization steps 70 and 80, a connection step is started wherein the client terminal 10 and the server terminal 30 are interconnected and carry out an exchange of messages/data associated, for example, to such applications as file transfer, web browsing, e-mail, videostreaming.

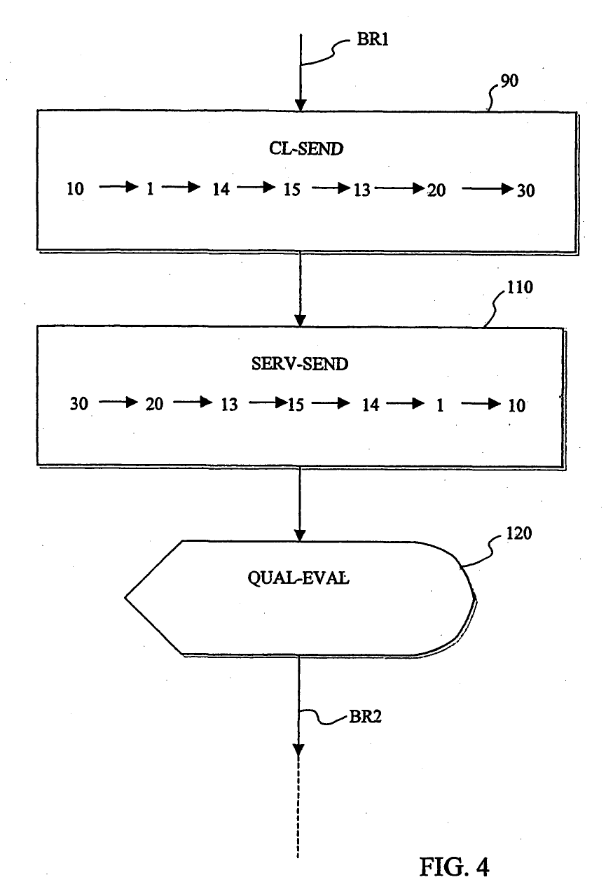

Referring to FIG. 4 (in which the flow chart from FIG. 3 is prosecuted by means of a first branch BR1), during the connection step the client terminal 10 carries out a first sending step 90 (CL-SEND) in which it sends signals (for example, packets of data corresponding to a request for further data) to first connection 1a, from which they are transmitted to the channel emulator 1. In the channel emulator 1 these signals undergo a processing that simulates the effects of the radio channel. This emulation can provide that the radio channel introduces a delay and/or a packet lost.

The signals resulting from the processing carried out by the radio channel emulator 1 are transmitted along the fifth connection 4 and, subsequently, they are received by the simulator/adapter 2. As already stated, according to the particular example described, the signals to the first connection 1a and fifth connection 4 respect an Ethernet-type protocol.

The third module 14 of the emulator/adapter 2 receives (by means of the fifth connection 4) the signals processed by the channel emulator 1. This third module 14 carries out, based on the configuration set by the second module 11, an adaptation of the format of the signals received by converting the communication protocol thereof such that they appear to the core network 20 as signals originated by the first user terminal associated to the client terminal 10. Moreover, the third module 14 inserts in these signals the parameters relative to the first user terminal and allocated during the second initialization step. For example, one of the functions performed by third module 14 is to carry out a IP address translation (Internet Protocol) between that allocated in the core network 20 for the first user terminal and that employed on fifth connection 4.

The signals (for example, data packets) from the third module 14 are processed by fifth module 15 which implements the user-plane protocols specific for the core network 20, by consequently reorganizing the data packets received.

The resulting packet flow is processed by the interface block 13 such as to be physically transmitted to the second connection 2a and reach the core network 20. The core network 20 treats this digital flow as it were originated by a typical real user terminal and sends it to the server terminal 30 by means of its switching and routing apparatuses.

In a second sending step 110 (SERV-SEND), the server terminal 30 sends the data requested by client terminal 10 through the connection 5a and through the core network 20, in a conventional manner. These data reach the interface block 13 of the emulator/adapter apparatus 2, which recognizes the typology thereof, i.e. recognizes them as being information for the user and not a control signal, and sends them to the fifth module 15. The fifth module 15 processes these data and carries out a conversion from the user-plane protocol employed by the core network 20 to that employed by the emulating apparatus 5 and, particularly, that employed on the fifth connection 4 and the first connection 1a.

The data converted by the fifth module 15 and directed to the first user terminal 10 are transmitted to third module 14. The third module 14 recognizes the addressee of these data (i.e. the first user terminal) and converts their address from that referred to the first user terminal to that of the client computer 10, consistent with the transmission modalities of the fifth connection 4 and the first connection 1a. These data are then processed by the channel emulator 1 and then sent to the client computer 10. The operation of the emulated system 100 in case of a further request of data by the client computer 10 will appear from the above description.

While carrying out the emulation, a quality evaluation step 120 (QUAL-EVAL) of the service associated to the connection between the client computer 10 and the server computer 30 can also be carried out. This quality evaluation can be carried out by suitable measure equipment (for example, error per packet or delay measures).

Advantageously, the operator can evaluate the quality directly from the client computer 10 without having to use measure equipment. For example, in the case of video-streaming, the evaluation of quality is carried out by observing the images present on a display of the client computer 10 with the naked eye.

Those skilled in the art will be easily adapt the above procedure in the case where the communication does not take place between the client computer and the server computer but between two client computers connected to the emulating apparatus 5.

As stated above, the method and system 100 of the invention allow to emulate a number of operative configurations and also to emulate variations of these configurations over time. For example, it is possible that during the setting step 60 second group parameters PAR_{US} have been generated which describe a situation in which the first terminal associated to the client computer remains in the first cell CELL1 for a certain time interval (for example, 10 minutes) and in the presence of a first condition of available radio resources and subsequently it moves to a second cell CELL2, in which it remains until the end of emulation (switching off of the first user terminal) and to which other conditions of availability of radio resources are associated. Particularly, it can be considered that in the second cell CELL2 there is an overcrowded condition in the first cell CELL1 worst than the emulated one. According to a particular exemplary embodiment of the invention, the variation of these conditions is emulated by a different behaviour of the radio channel assigned to the first terminal. Particularly, to the first cell CELL1 there are associated values of the third group parameters PAR_{CH} other than those associated to second cell CELL2.

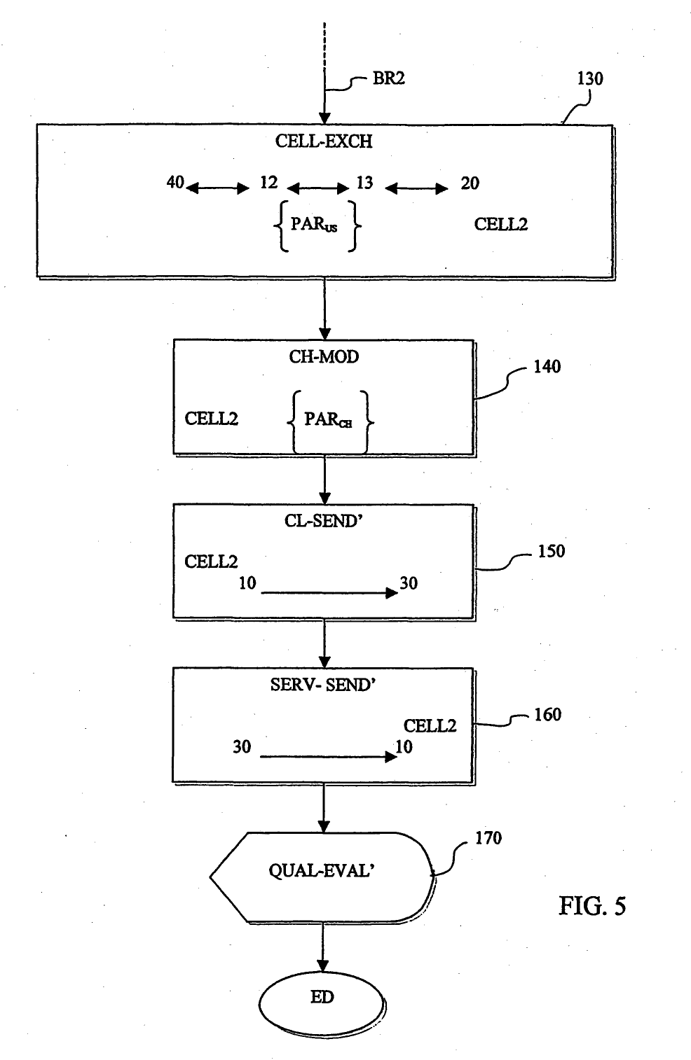

For the period of stay in the first cell CELL1, an example of the inventive method has already been described by the steps 50 to 120. The passage from second cell CELL2 and the operations carried out during the period of stay in this cell will be described below with reference to FIG. 5 (showing a flow chart linked to that from FIG. 4 by means of a second branch BR2). At the end of said period of stay, the control terminal 3, by generating a corresponding signal and sending it to second module 11, starts the emulation of the cell exchange. In a signalling step of the cell exchange 130 (CELL-EXCH), the second module 11 emits signals indicative of the cell exchange by the first user terminal and the quality of the service requested. These signals relative to the cell exchange undergo a protocol conversion carried out by the fourth module 12 and are sent by the interface block 13 to the core network 20. The core network 20 receives these signals and carries out an acceptation procedure of the cell exchange and the quality requested. In case of success of this procedure, the core network 20 signals to module 11 that the procedure has been successfully accomplished.

Moreover, in a radio channel modification step 140 (CH-MOD), the control terminal 3 controls the channel emulator 1 such that it simulates a radio channel corresponding to the particular values of the parameter third group PAR_{CH} being provided for this second situation. For example, having considered the second cell CELL2 as an overcrowded cell, the channel emulator 1 will emulate a situation where the radio channel has a narrower band (greater time delay) and is more disturbed than the previously simulated one.

In the above steps 130 and 140 it has been assumed, for example, that the previously established connection remains activated between the client computer and the server computer 30. For example, it is possible to consider a new message/data exchange between the client computer 10 and the server computer 30. This message/data exchange is outlined in the figure with a third request sending step 150 (CL-SEND′) by the client computer 10 and a fourth response data sending step 160 (SERVER-SEND′) by the server computer 30 which are analogous to the first and second sending steps 90 and 110, respectively.

Accordingly, a further quality evaluation 170 (QUAL-EVAL′) can be carried out in the second situation, by observing, for example, the images on the client computer 10 display. This observation will enable to fully evaluate the response by the emulated system 100, including the real core network 20, to the new situation.

As understood from the description above, it should be observed that the teaching of the present invention may be also applied to simulate a multiclient-server connection. In this case, another client computer is also comprised in the system 100 which is connected, together with the client computer 10, to the same server computer 30. The channel emulator 1 is such as to emulate also another radio channel associated to that other client computer, and the second module 11 is such as to emulate also a second user terminal associated to the further client computer. It is also possible to provide the emulation of peer-to-peer connections, where a data/information exchange between the client computer 10 and the further client computer is simulated.

Moreover, not only the interface block 13, but also other interface blocks (of a different typology) connected to other nodes of the core network 20 may be provided.

It should be noted that, despite the above example refers to a data connection, it is nevertheless possible to use the system 100 for emulating a “voice” connection with circuit switching and not packet switching.

The evaluation technique of the network performance according to the present invention offers noticeable advantages related to the fact that it allows to carry out an emulation of the radiomobile connection which is very similar to a real situation, thus enabling a very reliable evaluation of a connection quality. Particularly, this great reliability is also achieved due to the fact that a connection is provided to a real core network and not an emulated one. This allows to suitably consider, during emulation, also the interaction between the radio access network and the real core network, thus being able to observe any defect in the core network that may lead to a degradation of the connection.

In accordance with the inventive method, the other basic elements of a radiomobile communication system (the radio access network and the radio channel associated to a mobile terminal) are emulated such that the simulation is not deprived of the effects produced by these elements on the connection. It should be noted that, for example, the conventional Tekelec i300 apparatus and that of the patent application WO-03/028394, contrarily to what discussed herein, do not emulate the behaviour of the radio access network (or at least they do not emulate the behaviour of all the parts thereof) and, particularly, they do not produce signals linked to the topology of the radio access network. These conventional apparatuses cannot obtain results depending on the interaction between the radio access network and a core network.

Another advantage of the present invention lies in that the device connected to the emulating apparatus for which the quality evaluation is performed, is preferably a real device which, therefore, enables a direct analysis on the device itself and, in some cases, also by a simple observation with the naked eye without requiring any measure equipment.

1-36. (canceled)

37. A method for evaluating the performance of a radiomobile system comprising a core network, comprising the steps of generating a signal by means of a first device and transmitting said signal to a second device through said core network, wherein said transmission step comprises emulating a radio access network interposed between said first device and said core network.

38. The method according to claim 37, wherein said step of emulating a radio access network comprises emulating the behaviour of a radio channel associated with the first device.

39. The method according to claim 37, comprising the further step of emulating the behaviour of a first user mobile terminal associated with the first device.

40. The method according to claim 37, wherein said step of emulating a radio access network comprises exchanging with said core network information associated with a radiomobile connection of the first device to the second device and such as to allow the core network to recognize the emulated radio access network.

41. The method according to claim 37, comprising the further step of evaluating the quality of the transmission between the first and second devices based on said signal.

42. The method according to claim 37, wherein the first and second devices comprise a respective computer and the step of transmitting said signal comprises providing a connection of the client-server type to exchange data between the first and second devices.

43. The method according to claim 37, comprising the further step of emulating the behaviour of a second user mobile terminal associated with the second device.

44. The method according to claim 37, wherein said emulated radio access network is interposed between said second device and said core network.

45. The method according to claim 37, wherein said step of emulating a radio access network comprises the step of generating first signals indicative of a first plurality of parameters which may comprise defining a topology of the emulated access network.

46. The method according to claim 39, wherein said step of emulating the behaviour of a first user mobile terminal comprises the step of generating second signals indicative of a second plurality of parameters which may comprise defining the behaviour over time of said first user mobile terminal.

47. The method according to claim 38, wherein said step of emulating the behaviour of a radio channel associated with the first terminal comprises the step of generating third signals indicative of a third plurality of parameters which may comprise defining the behaviour over time of the emulated radio channel.

48. The method according to claim 45, wherein said step of emulating a radio access network further comprises a first step of access network initialization comprising the steps of:
sending signals describing the topology of the emulated access network and correlated to said first plurality of parameters to the core network; and
receiving a first signal of success of the first initialization step from said core network.

49. The method according to claim 48, wherein said first initialization step further comprises, before the step of sending said signals describing the topology of the emulated access network to the core network, the step of carrying out a conversion of said descriptive signals from a first protocol to a second user-plane protocol associated with the core network.

50. The method according to claim 47, wherein said step of emulating the behaviour of a first user mobile terminal further comprises a second step of user initialization comprising the steps of:
sending signals relative to a signalling procedure of the first terminal and correlated to said second plurality of parameters to the core network; and
receiving a second signal of success of the second initialization step by the core network.

51. The method according to claim 50, wherein said second initialization step further comprises, before the step of sending signals relative to a signalling procedure of the first terminal to the core network, the step of carrying out a conversion of said signals relative to the signalling procedure from a first protocol to a second protocol, said second protocol being a user-plane protocol associated with the core network.

52. The method according to claim 38, wherein said step of transmitting said signal comprises a first data sending step and wherein said step of emulating the behaviour of a radio channel comprises the steps of:
processing said data thus emulating the effect of the radio channel on said data;
associating with said processed data address information consistent with the address associated by the core network to the first terminal; and
processing the data with the address information associated therewith to arrange them according to a control-plane protocol specific for the core network.

53. The method according to claim 37, wherein said step of transmitting a signal comprises a second step of sending further data from the second device to the first device comprising the steps of:
receiving the further data supplied by said second device from the core network;
modifying the protocol associated with said further data;
processing said further data for emulating the effect of the radio channel; and
receiving said further data at the first device.

54. The method according to claim 47, wherein at least one between a first plurality of parameters, a second plurality of parameters, and a third plurality of parameters comprises at least a parameter variable over time which may comprise taking on a first value corresponding to a first configuration to be emulated and a second value corresponding to a second configuration to be emulated, when emulating a radio access network comprises generating first signals indicative of a first plurality of parameters which may comprise defining a topology of the emulated access network, or, when the method further comprises emulating the behaviour of a first user mobile terminal associated with the first device and comprises emulating the behaviour of a first user mobile terminal which comprises generating second signals indicative of a second plurality of parameters which may comprise defining the behaviour over time of a first user mobile terminal.

55. The method according to claim 37, wherein said radiomobile system is either a universal mobile telecommunications system or a general packet radio service system.

56. The method according to claim 37, wherein said signal comprises video data.

57. A system for evaluating the performance of a radiomobile transmission system comprising a core network, comprising: a first device operatively connected to said core network and suitable to generate a transmission signal; a second device operatively connected to said core network and suitable to receive said signal through said core network; and an emulating apparatus of a radio access network operatively interposed between said core network and at least one of said first and second devices.

58. The system according to claim 57, wherein said emulating apparatus comprises a radiomobile channel emulator.

59. The system according to claim 58, wherein said channel emulator is operatively connected to at least one of said first and second devices.

60. The system according to claim 58, wherein said emulating apparatus comprises a signalling and protocol adaptation emulator operatively interposed between said channel emulator and said core network.

61. The system according to claim 57, wherein said emulating apparatus comprises a user terminal emulator which is suitable to emulate the behaviour of a mobile terminal associated with one of said first and second devices.

62. The system according to claim 59, wherein said signalling and protocol adaptation emulator comprises a control-plane protocol transformation unit.

63. The system according to claim 59, wherein said signalling and protocol adaptation emulator comprises a user-plane protocol transformation unit.

64. The system according to claim 59, wherein said signalling and protocol adaptation emulator comprises an interface module network adapter suitable to adapt the interfacing to said core network.

65. The system according to claim 58, wherein said emulating apparatus is interposed between said first device and said network and wherein said second device is a server.

66. The system according to claim 58, wherein said emulating apparatus is interposed between said first and second devices and said network.

67. The system according to claim 66, wherein said emulating apparatus comprises a user terminal emulator suitable to emulate the behaviour of a first mobile terminal associated with said first device and a second mobile terminal associated with said second device.

68. An apparatus for emulating a portion of a radiomobile communication system, comprising:
a processing block suitable to receive and process signals generated by a communication device and transmitted on a radio channel; and
an interface/adaptation block to be connected to a core network of said radiomobile communication system and suitable to allow the exchange of said signals between the processing block and the core network.

69. The apparatus according to claim 68, wherein the processing block comprises an emulator of radio access network elements suitable to emulate the behaviour of at least part of a radio access network.

70. The apparatus according to claim 68, further comprising a radio channel emulator suitable to be interconnected between said communication device and said one processing block and to emulate the behaviour of said radio channel.

71. The apparatus according to claim 68, wherein said interface/adaptation block comprises a control-plane protocol transformer and a user-plane protocol transformer.

72. The apparatus according to claim 68, wherein said processing block comprises a user terminal emulator suitable to emulate the behaviour of a mobile terminal associated with said communication device.
